(19) United States
(12) Patent Application Publication
(10) Pub. No.: US 2014/0268324 A1
(43) Pub. Date: Sep. 18, 2014

(54) METHOD OF DISPLAYING 3D IMAGES FROM 2D SOURCE IMAGES USING A BARRIER GRID

(71) Applicant: 3-D Virtual Lens Technologies, LLC, New York, NY (US)

(72) Inventor: Eric Rosenthal, Morganville, NJ (US)

(73) Assignee: 3-D Virtual Lens Technologies, LLC, New York, NY (US)

(21) Appl. No.: 14/218,403

(22) Filed: Mar. 18, 2014

Related U.S. Application Data
(60) Provisional application No. 61/852,633, filed on Mar. 18, 2013.

(51) Int. Cl. G02B 27/22

(52) U.S. Cl. CPC G02B 27/2214
USPC 359/462

(57) ABSTRACT

Methods and systems are described for use of a barrier grid to enable the perception of three-dimensional (3D) content from inherently two-dimensional (2D) captured images. When viewing the captured image as a photograph, transparency or image displayed on an electronic display such as LCD, plasma, or DLP, a spacer and a barrier grid with vertical lines is placed in front of the display the barrier grid separates the horizontally displaced components of the image and directs the separated components to the left and/or right eye. Similarly, the image can be provided by a rear-projector screen, in which the image was stored and displayed digitally, photographically, or rendered by a computer device. The disparity contained in the horizontal displacement is perceived as depth information in the human brain. The result is that the perceived image is a three-dimensional representation of the actual depth information contained in the scene.

### RELATED APPLICATIONS

This application claims, pursuant to 35 U.S.C. §119, priority to, and the benefit of the earlier filing date of provisional patent application, entitled “Method of Displaying 3D Images from 2D Source Images Using a Barrier Grid,” filed on Mar. 18, 2013 and afforded Ser. No. 61/852,633, the contents of which are incorporated herein by reference in its entirety.

### TECHNICAL FIELD

This application generally relates to display of autostereoscopic three-dimensional (3D) and/or four dimensional (4D) images by use of a barrier grid in conjunction with two-dimensional (2D) images rendered on an image-forming display.

### BACKGROUND

Stereopsis was first described by Charles Wheatsone in 1838 (see, e.g., “Contributions to the Physiology of Vision.—Part the First. On some remarkable, and hitherto unobserved, Phenomena of Binocular Vision”, Charles Wheatsone, Philosophical Transactions of the Royal Society of London, Vol. 128, pp. 371-394, 1838.), which led to many attempts to achieve stereoscopic display by generating different images to the left and right eyes of a viewer using, for example, eye-glasses incorporating filters of a different color (e.g., red and cyan) or polarization for each eye.

Advances in computer graphics have created a recent resurgence in interest in multi-dimensional display, referred to as 3D (three-dimensions, referring to spatial dimensions) or 4D (adding the dimension of time) for motion pictures and television. Some of the commercial systems and content are based on various types of stereoscopic technologies, which each have deficiencies either in viewer experience or system cost or both. Visual deficiencies arise, in part, because human perception of 3D does not depend on the parallax embodied in stereoscopy alone, but also is affected by the focal distance of the eye, obscuration of an object in the background by a nearer object, relative angular motion of objects at different distances and saccadic motion. In fact, motion sickness and eye-strain are reported to result from viewing displays based on stereoscopy alone (see, e.g., “3D TV and Movies: Exploring the Hangover Effect”, J. Hecht, Optics & Photonics News, February 2011, p, 20-27).

Autostereoscopic systems do not rely on use of special eye-glasses. One method of autostereoscopy is to use lenticular lens arrays (see, e.g., U.S. Pat. No. 1,128,979, “Stereoscopic Picture,” W. Hess, Feb. 6, 1916). Another approach is the use of barrier grids (also known as “parallax barriers”) (see, e.g., Ives, Frederic E. (1902). “A novel stereogram”. Journal of the Franklin Institute 153: 51-52. doi:10.1016/S0016-0032(02)90195-X).

The principle underlying barrier grids is shown in FIG. 1. Images are acquired by two cameras, separated by approximately the interocular distance between eyes (which varies among individuals; a typically value for adult males is about 6 cm). The images are provided to adjacent columns of a display (e.g., an LCD), with one camera feeding data to odd numbered columns and the other camera feeding data to even numbered columns. The horizontal position of the display columns is determined by the size and resolution of the image panel. For example, a high-definition (HD) 1080p (having 1920 columns) LCD display with a 48″ horizontal dimension typically has 40 Bayer mask columns/inch, with each Bayer mask color pixel comprised of a red-green (RG) pair 211 and a green-blue (GB) pair 212 arranged as a 2×2 pattern 210, as exemplified by FIG. 2. The separations between the composite pixels in the figure are shown only for clarity. In practice, the pixels may have different geometries and may not be separated.

The barrier grid, 150, is separated from the display panel, 120, by S and has clear aperture, A, a blocking barrier of width W, and a repeat dimension of L. The viewer is a distance, D, in front of the barrier grid. As can be seen in the figure, the dimensions of the barrier grid can be selected to allow only the odd-numbered columns to be seen by one of the viewer's eyes and even-numbered columns to be seen by the other, giving rise to a stereoscopic effect.

Disparity is a major determinant of the perception of depth in binocular vision. Images formed on the retinas of left and right eyes appear to be displaced relative to one another because of the horizontal separation of the two eyes, typically ranging between 50 and 75 mm in adult humans. When viewing an object, the eyes rotate towards each other (convergence) so that the lines of sight of both eyes meet at a point in space. Binocular disparity is illustrated in FIG. 3. Convergence is the process by which the eyes rotate toward each other to select an object that will appear to have minimal three-dimensional information to reduce double vision. All other objects viewed in the scene with be binocularly displaced and the displacement generates a disparity in the two images that are combined to perceive depth.

In the figure, the left eye, 301, and right eye, 302, observe three points, 311, 312, and 313, at different distances from the eyes. Optical rays originating from 311, the farthest point, into the left eye, 301, are shown to follow a path that is incident on the retina of that eye at point 321. Rays from 311 into the right eye, 302, follow a path terminating in the retina of the right eye at point 331. Rays originating from point 312 are incident at points 322 on the retina of the left eye, 301, and 332 on the retina of the right eye, 302. Note, that in this case, the points 331 and 332 are coincident. Rays originating from point 313, the closest point, are incident on the retinas of the left eye at 323 and the right eye at 333, respectively. Thus, the images on the retinas of the left and right eyes appear to be shifted with respect to one another; the left retina detects three points in this case while the right retina detects only two points.

Human depth perception is not solely based on binocular vision but rather is formed from multiple cues. These include (but are not limited to): relative object size; dynamically changing object size; motion parallax, apparent relative motion of different objects; accommodation by each eye; occlusion of one object by another; and shadows. The inputs are integrated by the brain to generate the experience of depth perception.

### SUMMARY

Prior art uses barrier grids to provide autostereoscopic effects. Prior art uses multiple images to produce the disparity of image information to each eye. Disparity is a primary factor in enabling the human perception system to perceive depth. This disclosure teaches systems and methods of using one two-dimensional image to create disparity that enables a perception of depth by one or more viewers.

Commercially available LCD televisions use display technology in which pixels are aligned in column counts and spacing determined by the specific manufacturer. One application of the instant invention is to transform a standard 2D TV image into a 3D image. A 2D image is displayed on the display screen and, when viewed through a spacer and a barrier grid, a stereoscopic image is revealed. The stereoscopic effect depends strongly on correspondence of the dimensions of the barrier grid to the image panel specifications. The clear aperture of the barrier grid may be selected to optimize the brightness and clarity of the 3D display for a particular viewing situation. Narrow clear apertures yield images of higher apparent resolution but lower brightness.

When 2D images are captured using a single lens, single sensor, still image or moving image cameras the lens collects image information contained in the light field of the scene. The lens system optically focuses the image upside down and backwards on to an image sensor or photographic film. Each horizontal and vertical point of the sensor is exposed to a small portion of the reconstructed image (image component). In the lens system each image component reaches the sensor at an angle that is minutely different than the adjacent point of the sensor. When viewing the captured image as a photograph, transparency or image displayed on an electronic display such as LCD, plasma, or DLP, a spacer and a barrier grid with vertical lines is placed in front of the display the barrier grid separates the horizontally displaced components of the image and directs the separated components to the left and/or right eye. Similarly, the image can be provided by a rear-projector screen, in which the image is stored and displayed digitally, photographically, or rendered by a computer device. The disparity contained in the horizontal displacement is perceived as depth information in the human brain. The result is that the perceived image is a three-dimensional representation of the actual depth information contained in the scene.

According to embodiments of the present disclosure, systems and methods are disclosed for generating autostereoscopic 3D and/or 4D images from 2D image data rendering by a display device. Exemplary embodiments can include a display device configured to render 2D image data captured using a single lens, single sensor, still image or moving image cameras or can be a computer-generated image from a single point of view that replicates the optics of a camera sensor such that adjacent image components can be captured at an angle that is minutely different from each other. The 2D image data rendered by the display device can convey different perspectives (e.g., based on the angles at which the 2D image data is captured by a camera) that are generally undetected or un-noticeable when viewing the 2D image data via the device.

Exemplary embodiments of the present disclosure can also include a barrier grid disposed in front of, and spaced away from, the display device. The barrier grid can be a dynamic or static barrier grid that can have one or more specified parameters including, for example, a distance between the barrier grid and a screen of the display device, a repeat distance, light-blocking regions of a first width, and light transmitting regions of a second width. The parameters of the barrier and the distance between the barrier grid and the display device can be specified to facilitate the generation of a 3D and/or 4D image from the 2D image data. As one non-limiting example, in some embodiments, a ratio (e.g., an aspect ratio) between the first width and the second width can be 90:10 and 80:20. As another non-limiting example, a distance between the barrier grid and the screen of the display device can be between about a quarter of an inch (0.25 in.) and about one and a half inches (1.5 in.).

Any combination and/or permutation of embodiments is envisioned. Other objects and features will become apparent from the following detailed description considered in conjunction with the accompanying drawings. It is to be understood, however, that the drawings are designed as an illustration only and not as a definition of the limits of the invention.

### BRIEF DESCRIPTION OF THE DRAWINGS

FIG. 1 illustrates an autostereoscopic comprised of a barrier grid and image display panel.

FIG. 2 illustrates exemplary rows and columns of a Bayer mask displace matrix in which each of the RGGB sub-pixels is shown to be square as are the 2×2 composite pixels. The separations between the composite pixels in the figure are shown only for clarity. In practice, the pixels may have different geometries and may not be separated.

FIG. 3 illustrates disparity in binocular vision

FIG. 4 illustrates a barrier grid in front of a 2D display, showing how left and right eyes could have views of alternate columns.

FIG. 5 is a schematic diagram of an image display panel and an exemplary dynamically configurable barrier grid: (a) the barrier grid is turned off (i.e., is transparent); (b) the barrier grid is turned on to have an exemplary 20% aperture; and (c) the barrier grid is turned on to have an exemplary 40%.

FIG. 6 Illustrates: (a) an exemplary dynamically configurable barrier grid, e.g., formed on an LCD panel, used with a first image display panel; (b) an exemplary dynamically configurable barrier grid, e.g., formed on an LCD panel, used with a second image display panel.

FIG. 7 illustrates an autostereoscopic system in which an image is projected onto a screen by a rear projector with a barrier grid separated from the screen toward the viewing area.

### DETAILED DESCRIPTION

Exemplary embodiments of the systems and methods described herein are based on empirical observations of a perception of depth, i.e., 3D images, arising from viewing a standard 2D image through a barrier grid. The standard 2D image may be from a single camera or rendered from a single point of perspective, in distinction to autostereoscopic systems and methods of prior art wherein the input data to columns of a display are imaged through two or more cameras or rendered from two or more points of perspective.

An exemplary system for generating autostereoscopic 3D and/or 4D images from 2D images (e.g., a scene) captured, for example, by a single camera or rendered from a single point of perspective is shown in FIG. 4. Static or dynamic 2D image data is input to an image display panel, 420. As described herein, the 2D data image can be captured using a single lens, single sensor, still image or moving image cameras or can be a computer-generated image from a single point of view that replicates the optics of a camera sensor. Each horizontal and vertical point of the sensor of the camera that captures the 2D image can be exposed to a small portion of the reconstructed image (image component) that reach the sensor at an angle that is minutely different than the adjacent point of the sensor. The captured 2D image data can be rendered on the image display panel 420 as a standard 2D image (e.g., a true copy of the 2D image data captured by the camera can be rendered by the image display panel) and the image components can be distributed horizontally across the image display panel 420. For example, a standard high definition 2D television broadcast (e.g., 1080i, 1080p) can be rendered on the image display panel 420. By rendering the 2D image data on the image display panel as a generally true copy of the captured image, the image display panel 420 can convey different perspectives (e.g., based on the angles at which the 2D image data is captured by the camera) that are generally undetected or un-noticeable when viewing the 2D image data via the image display panel 420. An exemplary panel may display the 2D image data as 1080 rows by 1920 columns. Alternatively, the 2D image data may be a photograph or other static rendering of sufficiently high resolution.

A barrier grid 450 comprised of vertical lines is positioned a distance, S, in front of the 2D image display. The barrier grid, 450, has repeat distance L, with light-blocking regions, 470, of width W and light transmitting regions, 460, of width A. The system is viewed at a distance, D, in front of the barrier grid. As shown in the figure, light rays originating at any column may or may not be able to travel through a light-transmitting area, 460, to be observed by either or both of the left eye, 411, and right eye, 412. The light blocking regions 470 of the barrier grid 450 can be placed in front of the display panel to separate the horizontally displaced image components of the rendered 2D image data (e.g., the image components distributed horizontally across the image display panel 420) and to direct the separated horizontal displaced image components to the left and/or right eye so that the perceived image rendered by the image display panel 420 in conjunction with the barrier grid 450 is a three-dimensional representation of the actual depth information contained in the captured 2D image data.

Experimentally, barrier grids having 12 lines/inch, i.e., L=0.083″ were positioned in front of a 55″ diagonal HD TV LCD display having 1920 columns×1080 rows. The width of the active area of the display is 47.5″; therefore the column repeat distance on the display is approximately 0.025″ (40 columns/inch).

Test 2D images were displayed as described herein and barrier grids having different aspect ratios, W:A, were positioned in front of the display panel. A correct sense of depth was perceived, i.e., objects that were intended to be farther from the viewer (background) and objects that were intended to be nearer to the viewer (foreground) were perceived as such for barrier grids in which the aspect ratio was 90:10 and 80:20. The perception of depth was less evident when a grid having an aspect ratio of 70:30 was used. Depth was not perceived using a screen having an aspect ratio of 60:40 or less. The use of high aspect ratios (narrow light-transmitting areas) decreases the brightness and perceived resolution of the image, as expected. No pseudoscopic artifacts, i.e., reversal of left and right images, a persistent deficiency of conventional barrier grid autostereoscopic systems, were observed

The range over which the perception of depth in the image was strongest was observed as a function of the separation, S, between the display panel and barrier grid and is shown in Table I, which shows minimum and maximum distances over which 3D is perceived in an image as a function of separation between the display panel and barrier grid.

TABLE I

| S | Optimal Viewing |
|---|---|
| (inches) | Distance (feet) |
| 0.50 | 9-12 |
| 0.75 | 6-9 |
| 1.25 | 3-6 |

Perception of depth content vanishes if only one eye is used to view the image. Similarly, there is no perception of depth if the barrier grid is aligned so that the grid lines are horizontal rather than vertical. These observations strongly suggest that the perception of depth arises from binocular disparity.

The above empirical observations, based on the display column width, grid periodicity, S, and optimal viewing distance suggest that the columns visible to one eye do not arise from adjacent columns. It is possible that each eye sees a set of columns that is partially different from those observed by the other eye.

Optimization of the grid parameters requires careful selection of its parameters, both to maximize depth perception and minimize or eliminate color-fringing arising from optical interference between the barrier grid and pixel structure of the display device. Once grid parameters are selected, the spacing between the image panel and barrier grid, S, is varied to yield a range over which 3D is observed that is suited to the application. For example, the desired optimal viewing distance for a gaming device might be less than that for a large TV.

The barrier grid may be a variable barrier grid in which the aspect ratio, W:A, can be adjusted dynamically. An exemplary embodiment of such a variable barrier grid is an LCD panel, having sufficiently narrow columns such that the widths of the light-blocking areas, 470, and light-transmitting areas, 460, can be selected by addressing the appropriate column drivers of the dynamic barrier grid.

In an exemplary embodiment illustrated in the schematic diagrams depicted in FIGS. 5a-c, 2D image data is provided to a first image display LCD panel, 510, while a dynamically configurable barrier grid is formed on a second LCD panel, 520. The 2D image data can be captured in a similar manner as the 2D image data described herein, e.g., with respect to FIG. 4. FIG. 5a depicts the barrier grid formed on the second LCD panel 520 turned off (i.e., transparent). FIG. 5b depicts the barrier grid formed by the second LCD panel 520 turned on to have an exemplary 20% aperture. FIG. 5c depicts the barrier grid formed by the second LCD panel turned on to have an exemplary 40%. Cooperative display of the 2D image data on the image display panel, 510, and the barrier grid on the second panel, 520, enables autostereoscopic viewing of 3D and/or 4D images based on the rendering of the 2D image data by the first image display LCD panel. FIG. 5a shows the dynamically configurable barrier grid turned off or in a deactivated state, in which the entire second LCD panel, 520, is transparent and devoid of alternative light-blocking portions. Configuration of the dynamically configurable barrier grid to be in the deactivated state on the second LCD panel, 520, enables 2D viewing of 2D images on the image display panel, 510.

When the dynamically configurable barrier grid is turned on or activated, one or more grid characteristics may be set or configured including, but not limited to, the width of the light-blocking portions, the width of the light-transmitting portions, the repeat dimension L, the ratio of the width of the light-blocking portions to the width of the light-transmitting portions, the total width of the barrier grid, the total height of the barrier grid, and the like. Upon activation of the barrier grid, one or more grid characteristics may be re-set or changed including, but not limited to, the width of the light-blocking portions, the width of the light-transmitting portions, the repeat dimension L, the ratio of the width of the light-blocking portions to the width of the light-transmitting portions, the total width of the barrier grid, the total height of the barrier grid, and the like. The grid characteristics may be specified in one or more grid indicia received from a user, a processing device or module internal to the autostereoscopic display system, external to the autostereoscopic display system, and the like. Upon receiving the grid indicia, the second LCD panel, 520, may be configured either to be completely transparent (i.e., not display a barrier grid or display a deactivated barrier grid) or to display alternating vertical light-blocking and light-transmitting portions (i.e., display a barrier grid) according to the specifications of the grid indicia.

In an exemplary embodiment, the width of the light-blocking portions may be configured to be greater than the width of the light-transmitting portions. In some exemplary embodiments, the width of the light-blocking portions may be configured to be about two to five times greater than the width of the light-transmitting portions. As shown in FIG. 5b, an exemplary first barrier grid is turned on with a 20% clear aperture, i.e., with a width ratio between the light-blocking portions, 521, to the light-transmitting portions, 522, of about 4:1. As shown in FIG. 5c, an exemplary second barrier grid is turned on with a 40% clear aperture, i.e., with a width ratio between the light-blocking portions, 521, to the light-transmitting portions, 522, of about 3:2. In exemplary embodiments, the first barrier grid shown in FIG. 5b may be configured (i.e., the widths of the light-transmitting and/or light-blocking portions of the first barrier grid may be changed) to generate the second barrier grid shown in FIG. 5c. Similarly, the second barrier grid shown in FIG. 5c may be configured (i.e., the widths of the light-transmitting and/or light-blocking portions of the first barrier grid may be changed) to generate the first barrier grid shown in FIG. 5b. One of ordinary skill in the art will recognize that width ratios between the light-blocking portions, 521, to the light-transmitting portions, 522, are not limited to the illustrative width ratios shown in FIGS. 5b and 5c, and that exemplary barrier grids may be configured using any suitable width ratio suitable for generating an autostereoscopic 3D and/or 4D image from 2D image data described herein.

The grid characteristics of an exemplary dynamically configurable barrier grid may be tuned or configured to improve depth perception. In some exemplary embodiments, as the width of the light-blocking portions 521, W, is increased to or beyond approximately 50% of the repeat dimension, L, it becomes possible to perceive depth in the images displayed on the first LCD panel, 510. As the width of the light-blocking portions 521, W, is increased further, clarity is improved at the expense of brightness as the barrier grid obscures a higher percentage of the image display panel. Experimental results show that an improved tradeoff between clarity and brightness is achieved at approximately W/L=80%. At this level of W/L, the images viewed on the first LCD panel, 510, enable depth perception and are bright and clear for an improved viewing experience. Further, because the human brain integrates visual inputs, the zone over which depth in moving images are perceived is an extended zone that depends on the size and resolution of the display panel and the dimensional parameters of the barrier grid.

In an exemplary embodiment, the grid characteristics of a dynamically configurable barrier grid may be configured to match the size of the image display panel, 510. Exemplary embodiments may determine or receive the size of the image display panel, 510, and automatically determine the grid parameters that are suitable for an image display panel of that size.

In an exemplary embodiment, the grid characteristics of a dynamically configurable barrier grid may be configured to determine the best viewing distance of a viewer from the image display panel, 510.

In an exemplary embodiment, the grid characteristics of a dynamically configurable barrier grid may be configured to set or alter the brightness of images viewed on the image display panel, 510. Exemplary embodiments may increase the width of the light-blocking portions, 521, relative to the width of the light-transmitting portions, 522, of the barrier grid in order to decrease the brightness of the images viewed and, conversely, may decrease the width of the light-blocking portions, 521, relative to the width of the light-transmitting portions, 522, of the barrier grid in order to increase the brightness of the images viewed. In an exemplary embodiment, a brightness setting may be received from a user or from a processing device or module external to the second display panel, 520, and, in response, the grid characteristics of the barrier grid may be altered to achieve the brightness setting. In an exemplary embodiment, an ambient or room brightness may be detected (e.g., using a light sensor) and a desired brightness of images in the display system may be determined based on the ambient brightness. For example, in a dimly lit room, the image brightness may be adjusted downward to improve the viewing experience. Based on the image brightness determined based on the ambient brightness, exemplary embodiments may, in turn, configure the grid characteristics of the barrier grid to achieve the desired image brightness.

Once the grid characteristics of the dynamically configurable barrier grid are configured, the spacing between the image display panel, 510, and the second LCD panel, 520, displaying the barrier grid, S, may be varied to yield a viewing distance range over which autostereoscopic 3D images are observed. For example, the desired viewing distance for a gaming device might be less than that for a large TV.

In an embodiment, the occluding pixels of a dynamically configurable barrier grid may be selected to conform to image display panels having differing column pitch values to facilitate generating an autostereoscopic 3D and/or 4D image from 2D image data as described herein. This allows the same display panel for displaying a dynamically configurable barrier grid to be configured to and be used cooperatively with different image display panels having different values of the column pitch. As shown in FIG. 6a, a first image display panel, 610, having a column width of C1 is provided. A barrier grid, 620, having a column width P and a repeat dimension of L1 is provided cooperatively with a first image display panel, 610. The repeat dimension of the barrier grid, L1, in the example shown is equal to 10 barrier grid column widths, P. In the example shown, the column width P of the barrier grid, 620, is configured to be substantially equal to the column width C1 of the first image display panel, 610. Three columns of the barrier grid are selected to be transparent, yielding a clear aperture of A1=3P and seven pixels are selected to be opaque, yielding a barrier that occludes W1=7P. The barrier grid, 620, is configured so that the ratio of the clear aperture selected to the repeat dimension, A1/L1, is 30%. The width of each light-transmitting portion, A, corresponds to the combined width of three image display panel columns, 3C1 (and similarly, to three barrier grid columns 3P). As an example, the first image display panel, 610, may have 1280 columns across a 48″ horizontal width, with each column being 0.0375″ wide. The display, therefore, has 26⅔ columns/inch.

FIG. 6b shows the same barrier grid LCD panel used with a second image display panel having a smaller column width, C2, corresponding, for example, to a panel having 1920 columns to facilitate generating an autostereoscopic 3D and/or 4D image from 2D image data described herein. The horizontal extent of the image display panel is again assumed to be 48″. Thus, each column of the second image display panel is 0.025″ in width, corresponding to about 40 columns/inch. FIG. 6b shows two barrier grid columns being transparent, yielding a clear aperture of A2=2P. In this example, the repeat distance of the grid, L2, is equal to nine barrier grid LCD columns, again yielding a barrier width W2=7P. Each of the repeat distance, L, barrier width, W, and clear aperture, A, may be selected to be an integral number of barrier grid LCD column widths, subject to the constraint that L=A+W.

In another embodiment, the occluding pixels of the barrier grid are selected to conform to image display panels of differing column pitch. As shown in FIG. 6(a), a barrier grid having a repeat distance of L is used with a first image display panel to facilitate generation of an autostereoscopic 3D and/or 4D image from 2D image data described herein. In the example shown, the clear aperture selected, A₁, is 20%, and corresponds to one column pitch having a column width, C₁. As an example, the first image display may have 1280 columns across a 48″ horizontal width, with each column being 0.0375″ wide. The display, therefore, has 26⅔ columns/inch. The barrier grid is provided having a column width, P. The repeat distance of the grid is L₁. In this example, three columns of the barrier grid are selected to be transparent, yielding a clear aperture of A₁=3P and seven pixels are selected to be opaque, yielding a barrier that occludes W₁=7P. FIG. 6(b) shows the same barrier grid used with a display panel having a smaller column width, C₂, corresponding, for example to a panel having 1920 columns. The horizontal extent of the image display panel is again assumed to be 48″. Thus, each column of the barrier grid is 0.025″ in width, corresponding to 40 columns/inch.

FIG. 7 shows an exemplary embodiment in which a 2D image is projected from the rear onto a screen using 2D image data described herein. A vertical barrier grid is spaced away from the screen toward the front viewing area, i.e., on the opposite side of the screen from the projector. The projector may provide still or moving digital or analog images.

Barrier grids, such as illustrated in FIGS. 1, 4, 5b, 5c, 6a, and 6b, are comprised of a plurality of parallel, closely spaced occluding and transmitting regions that are generally oriented so that the transmitting regions are vertical slits. These slits define a narrow aperture, which may contribute to an improved perception of clarity or sharpness in the viewed autostereoscopic image as follows: (1) The depth of field is increased, thus images which would have been perceived as less sharp or blurry when viewed without a barrier grid have improved apparent sharpness when viewed through such a barrier grid. (2) The use of a barrier grid reduces diffusion artifacts from adjacent pixels so the light from an individual pixel is perceived without admixture of light emitted by adjacent pixels.

Exemplary high-definition (HD) display panels comprising 1920×1080 pixels have been described in this disclosure. Display panels having even greater numbers of pixels are available both for professional applications and, recently, for consumer use, the latter being the so-called “4K” displays, which are comprised of 3840×2160 pixels. The pixels comprising such higher-density display panels are closer together than the angular resolution of the eye at viewing distances typically of autostereoscopic display system and, therefore, do not improve the perceived angular resolution significantly.

The clear aperture of the barrier grid may be selected to optimize the brightness and clarity of the 3D display for a particular viewing situation. Narrow clear apertures yield images of higher apparent resolution but lower brightness.

A dynamically configurable barrier grid allows the creation of a grid in one or more sub-sections of the display system. For example, a 640×480 rectangular window, a circle window having a diameter of a chosen number of pixels, or any arbitrary shape can be selected to allow combination and display of 2D and 3D content on one screen. An exemplary use of such a combination is a 3D image of a body part during a medical procedure or of a mechanical component enhanced by proximate areas of 2D text describing the 3D image. In other exemplary uses, the concept can also be applied to 2D annotation of 3D videos or video games.

What is claimed is:

1. A method for creating an autostereoscopic image, the method comprising:
providing a two-dimensional image;
providing a barrier grid, which transmits a first portion of incident light and blocks a second portion of incident light, the barrier grid being separated from the two-dimensional image by a distance that enables autostereoscopic viewing.

2. The method of claim 1 in which the barrier grid is positioned on the front side and separated from the two-dimensional image.

3. The method of claim 2 in which the barrier grid is configurable to include a plurality of configurable alternating light-transmitting portions and light-blocking portions.

4. The method of claim 2 in which the two-dimensional image is formed on an image display panel.

5. The method of claim 1 in which the image is rear-projected onto a screen.

6. The method of claim 2 in which the two-dimensional image is a photograph.

7. The method of claim 2 in which the two-dimensional image is a rendered image.

8. The method of claim 1 in which the barrier grid acts as a plurality of apertures such that the perceived clarity of the autostereoscopic image is improved compared to a system wherein no barrier grid is provided.

9. The method of claim 2 in which the barrier grid indicia can be changed to adjust the brightness of the perceived image.

10. The method of claim 1 in which the two-dimensional image is a photograph.

11. The method of claim 1 in which the two-dimensional image is a rendered image.

12. The method of claim 1 in which the barrier grid is made transparent in selected areas, allowing viewing of 2D images in said selected areas adjacent to areas in which 3D images may be viewed.

13. A system for creating an autostereoscopic image, the system comprising:
an image input device that provides a two-dimensional image;
a barrier grid, which transmits a first portion of incident light and blocks a second portion of incident light, the barrier grid being separated from the image display device by a distance that enables autostereoscopic viewing;

14. The system of claim 13 in which the barrier grid is positioned on the front side and separated from the two-dimensional image.

15. The system of claim 14 in which the barrier grid is configurable to include a plurality of configurable alternating light-transmitting portions and light-blocking portions.

16. The system of claim 14 in which the two-dimensional image is formed on an image display panel.

17. The system of claim 13 in which the image is rear-projected onto a screen.

18. The system of claim 14 in which the two-dimensional image is a photograph.

19. The system of claim 14 in which the two-dimensional image is a rendered image.

20. The system of claim 13 in which the barrier grid acts as a plurality of apertures such that the perceived clarity of the autostereoscopic image is improved compared to a system wherein no barrier grid is provided.

21. The system of claim 14 in which the barrier grid indicia can be changed to adjust the brightness of the perceived image.

22. The system of claim 13 in which the two-dimensional image is a photograph.

23. The system of claim 13 in which the two-dimensional image is a rendered image.

24. The system of claim 13 in which the barrier grid is made transparent in selected areas, allowing viewing of 2D images in said selected areas adjacent to areas in which 3D images may be viewed.
